(19) United States
(12) Patent Application Publication
(10) Pub. No.: US 2020/0007661 A1
(43) Pub. Date: Jan. 2, 2020

(54) METHOD AND APPARATUS FOR SETTING CONNECTION BETWEEN VEHICLE AND SERVER IN AUTOMATED VEHICLE & HIGHWAY SYSTEMS

(71) Applicant: LG Electronics Inc., Seoul (KR)

(72) Inventor: Soryoung KIM, Seoul (KR)

(21) Appl. No.: 16/568,866

(22) Filed: Sep. 12, 2019

(30) Foreign Application Priority Data
Jul. 31, 2019 (KR) 10-2019-0093510

(51) Int. Cl. H04L 29/06; G05D 1/00; G08G 1/01; H04W 4/48

(52) U.S. Cl. CPC H04L 67/42; G05D 1/0022; H04W 4/48; G08G 1/0116; G08G 1/012

(57) ABSTRACT

In automated vehicle & highway systems, the vehicle request server information for establishing a communication connection to a server to a base station, receives the server information related to one or more servers connected to the base station, determines a first server to execute a function required by an application of the vehicle based on the server information, and establishes the communication connection to the first server. Accordingly, it is possible to select the most suitable server for executing the function required by the application of the vehicle. Sharing a computing resource with other vehicles is executed to efficiently process data. At least one of an autonomous vehicle, a user terminal, and a server of the present disclosure is associated with an artificial intelligence module, an unmanned aerial vehicle (UAV) robot, an augmented reality (AR) device, a virtual reality (VR) device, and a device related to a 5G service.

### CROSS-REFERENCE TO RELATED APPLICATION

This application claims the benefit of Korean Patent Application No. 10-2019-0093510, filed on Jul. 31, 2019. The contents of this application are hereby incorporated by reference in its entirety.

### BACKGROUND OF THE INVENTION

### Field of the Invention

The present disclosure relates to automated vehicle & highway systems, and particularly, a method and an apparatus for setting a connection between a vehicle and a server.

### Related Art

Vehicles can be classified into an internal combustion engine vehicle, an external composition engine vehicle, a gas turbine vehicle, an electric vehicle, etc. according to types of motors used therefor.

An autonomous vehicle refers to a self-driving vehicle that can travel without an operation of a driver or a passenger, and automated vehicle & highway systems refer to systems that monitor and control the autonomous vehicle such that the autonomous vehicle can perform self-driving.

### SUMMARY OF THE INVENTION

The present disclosure suggests a method for connecting a suitable server capable of executing a function required by an application of a vehicle.

The present disclosure also suggests a method for temporarily connecting a loss countermeasure server when a connection to the server is lost.

The present disclosure also suggests a method for searching and connecting a suitable server capable of substituting for the loss countermeasure server.

Technical objects to be solved by the present disclosure are not limited to the technical objects mentioned above, and other technical objects that are not mentioned will be apparent to a person skilled in the art from the following detailed description of the invention.

In an aspect, a method for setting a connection between a vehicle and a server in automated vehicle & highway systems is provided. The method includes requesting server information to a base station to establish a communication connection to the server and receiving the server information related to one or more servers connected to the base station; determining a first server to execute a function required by an application of the vehicle, based on the server information; and establishing the communication connection to the first server. The server information includes function information executable based on an Internet Protocol (IP) address of the server and specifications of the server, and the function information may include a priority value.

When the communication connection to the first server is lost, the method may further include: transmitting a search information request message for searching a loss countermeasure server that is an alternate server of the first server; setting the loss countermeasure server based on the search information; and establishing a communication connection to the loss countermeasure server, and the search information may include traffic status information of the server and communication status information that indicates whether a communication connection to the vehicle is possible.

The function information may include a single data processing function for processing a single data type, a media data processing function for processing a media data type, and a data combination function for combining and processing different data types.

The server information may further include traffic information of the server, and the determining the first server may include determining, based on the function information and the traffic information, a server that is mapped to a function required by the application and has a lowest current traffic, as the first server.

When the function required by the application includes an object detection function or a media streaming function, the function required by the application may be mapped to the media data processing function.

When the function required by the application includes map information generation function or a traveling route search function based on traffic information, the function required by the application may be mapped to the data combination function.

The setting the loss countermeasure server may include setting a server, which has a communication status connectable to the vehicle and has a lowest current traffic, as the loss countermeasure server.

The method may further include receiving server information of a second server that is an alternate server of the loss countermeasure server, and the second server may execute a function mapped to the function required by the application based on the server information of the second server and have a traffic status that executes the function.

In another aspect, a method for setting a connection between a server and a vehicle in automated vehicle & highway systems is provided. The method includes establishing a communication connection to the vehicle, and requesting a search for an alternate server playing a role of the server to a Cloud server when the server is set to the loss countermeasure server. The loss countermeasure server is a server that is temporarily connected to the vehicle to prevent loss of data related to an operation executed by the application caused by a communication disconnection to the server connected to the application of the vehicle.

In still another aspect, a vehicle executing a method for setting a connection between a vehicle and a server in automated vehicle & highway systems is provided. The vehicle includes a communication module; a memory; and a processor. The processor requests server information for establishing a communication connection to the server to a base station through the communication module, receives the server information related to one or more servers connected to the base station, determines a first server to execute a function required by an application of the vehicle based on the server information, and establishes the communication connection to the first server. The server information includes function information executable based on an Internet Protocol (IP) address of the server and specifications of the server, and the function information may include a priority value.

### BRIEF DESCRIPTION OF THE DRAWINGS

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 shows a vehicle according to an embodiment of the present disclosure.

FIG. 6 is a control block diagram of the vehicle according to an embodiment of the present disclosure.

FIG. 7 is a control block diagram of an autonomous device according to an embodiment of the present disclosure.

FIG. 8 is a diagram showing a signal flow in an autonomous vehicle according to an embodiment of the present disclosure.

FIG. 9 is a diagram referred to describe a usage scenario of a user according to an embodiment of the present disclosure.

FIG. 10 is an example of V2X communication to which the present disclosure is applicable.

FIGS. 11A and 11B show a resource allocation method in a side-link where the V2X is used.

FIG. 12 shows an architecture of a mobile edge computing (MEC) server applicable to the present disclosure.

FIG. 13 is an embodiment of a vehicle to which the present disclosure is applicable.

FIG. 14 is an embodiment of a server to which the present disclosure is applicable.

FIG. 15 is an example of setting of the suitable server to which the present disclosure is applied.

FIG. 16 shows an example in which a connection to the server applied to the present disclosure is lost.

FIG. 17 is a diagram showing a configuration of the server to which the present disclosure is applied.

The accompanying drawings, which are included as a part of detailed descriptions to aid understanding of the present disclosure, provide an embodiment of the present disclosure and, together with the detailed description, explain technical features of the present disclosure.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

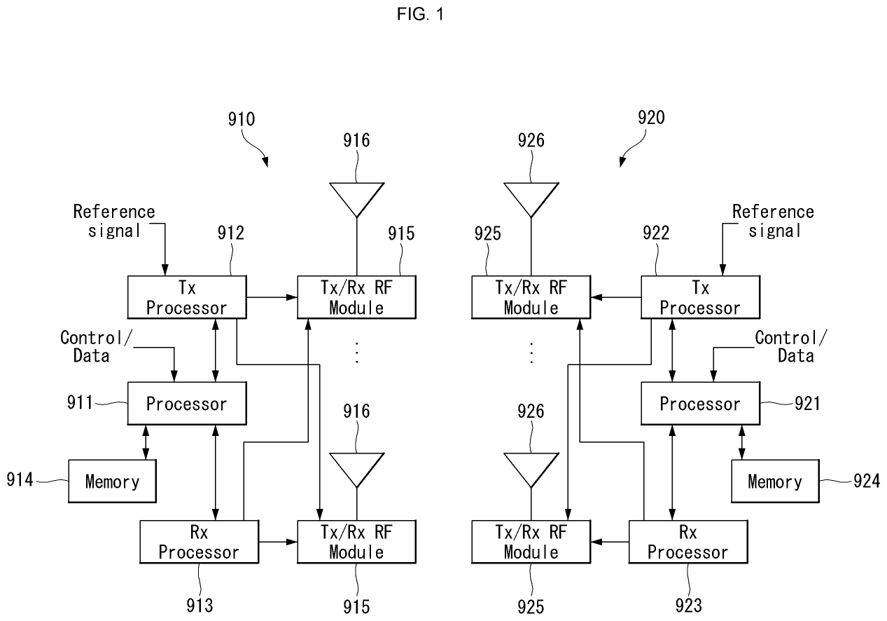

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

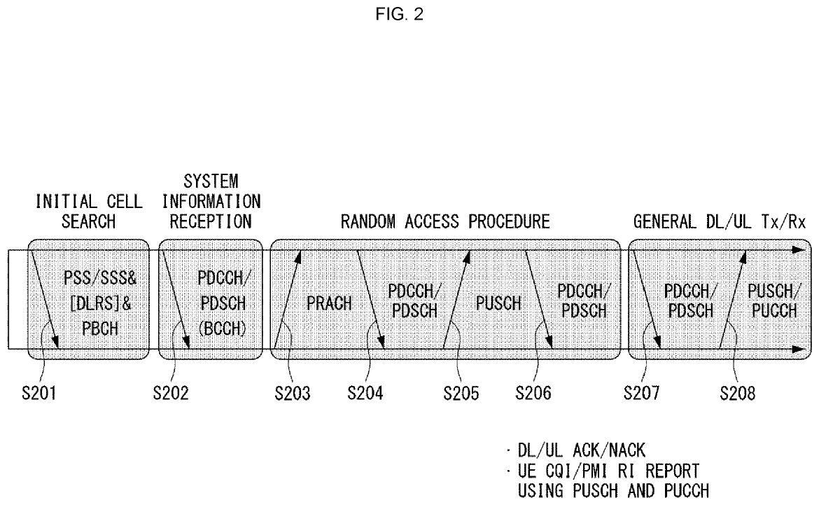

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent path loss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList”represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to “beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

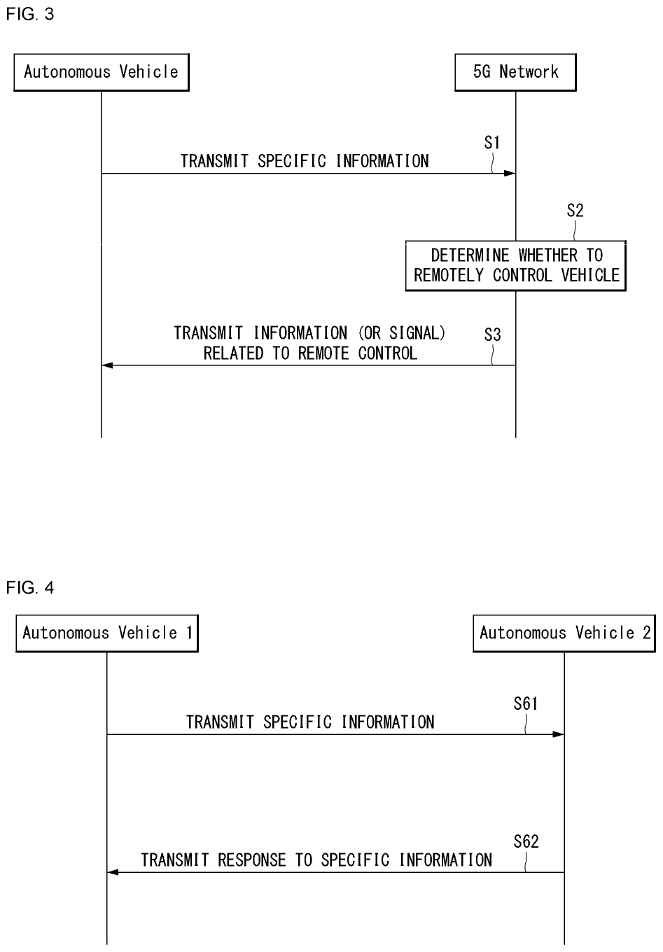

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied operations between autonomous vehicle and 5G network in 5G communication system

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (side-link communication transmission mode 3) or indirectly (side-link communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical side-link control channel (PSCCH) is a 5G physical channel for scheduling of transmission of specific information a physical side-link shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present disclosure which will be described later and applied or can complement the methods proposed in the present disclosure to make technical features of the methods concrete and clear.

Driving

(1) Exterior of Vehicle

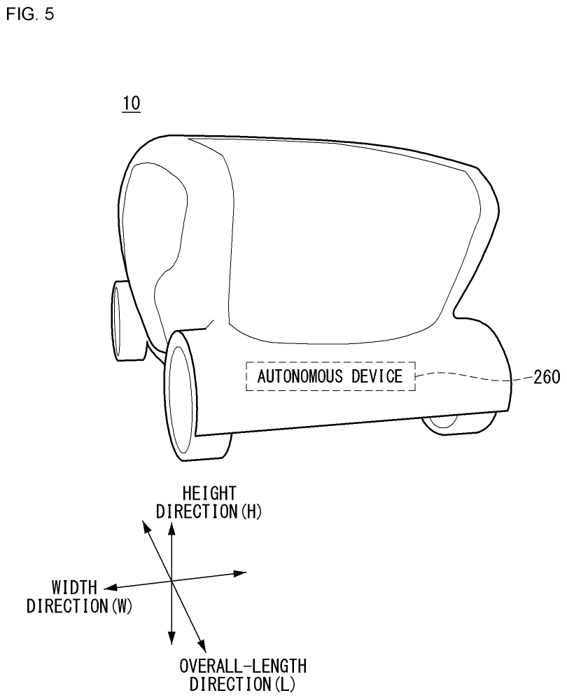

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

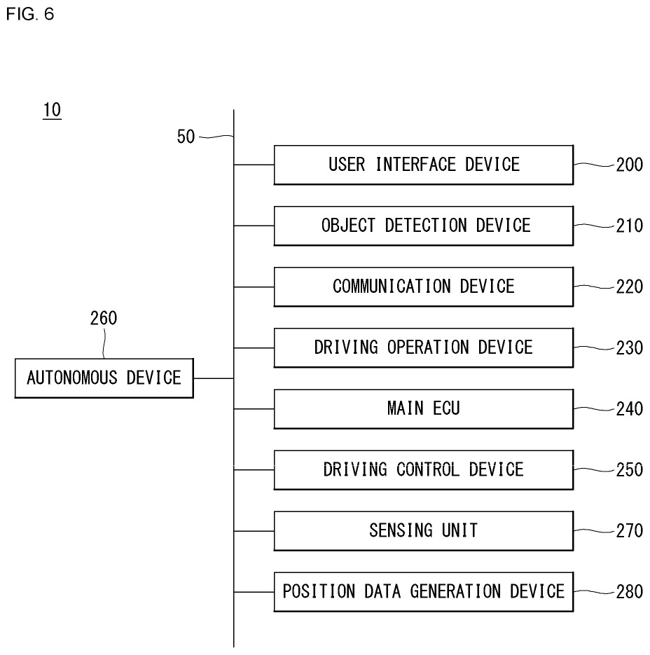

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include side-link communication based on LTE and/or side-link communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

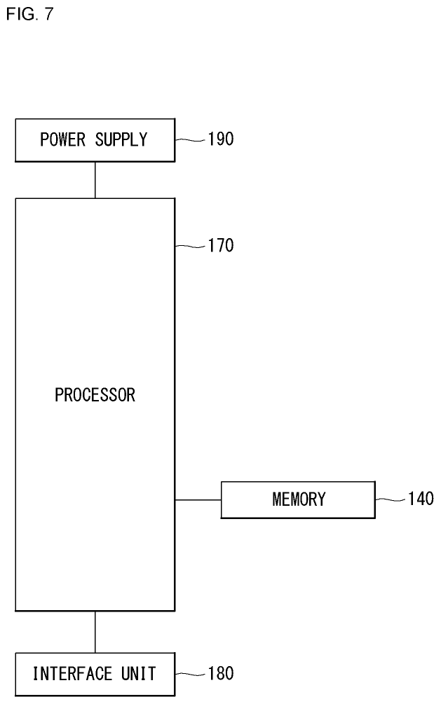

FIG. 7 is a control block diagram of the autonomous device according to an embodiment of the present disclosure.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

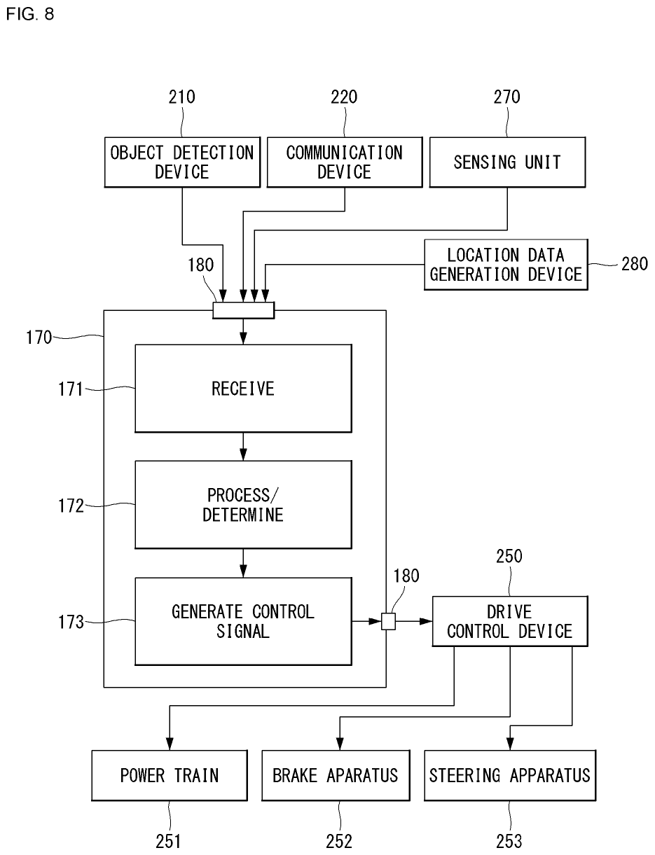

FIG. 8 is a diagram showing a signal flow in an autonomous vehicle according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 253.

Autonomous Vehicle Usage Scenario

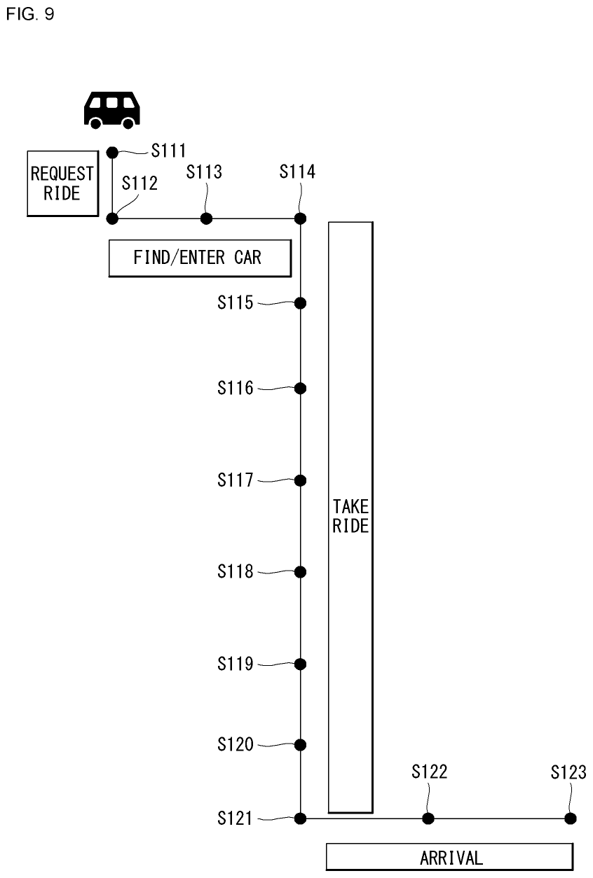

FIG. 9 is a diagram referred to describe a usage scenario of the user according to an embodiment of the present disclosure.

1) Destination Forecast Scenario

A first scenario S111 is a destination forecast scenario of the user. A user terminal may install an application that can be linked with a cabin system. The user terminal can forecast the destination of the user through the application based on user's contextual information. The user terminal may provide vacant seat information in a cabin through the application.

2) Cabin Interior Layout Countermeasure Scenario

A second scenario S112 is a cabin interior layout countermeasure scenario. The cabin system may further include a scanning device for acquiring data on the user located outside a vehicle 10. The scanning device scans the user and can obtain physical data and baggage data of the user. The physical data and baggage data of the user can be used to set the layout. The physical data of the user can be used for user authentication. The scanning device can include at least one image sensor. The image sensor can use light in a visible light band or an infrared band to acquire an image of the user.

The seat system 360 can set the layout in the cabin based on at least one of the physical data and baggage data of the user. For example, the seat system 360 may provide a baggage loading space or a seat installation space.

3) User Welcome Scenario

A third scenario S113 is a user welcome scenario. The cabin system may further include at least one guide light. The guide light may be disposed on a floor in the cabin. The cabin system may output the guide light such that the user is seated on the seat, which is already set among the plurality of sheets when user's boarding is detected. For example, a main controller 370 may implement moving light through sequential lighting of a plurality of light sources according to the time from an open door to a predetermined user seat.

4) Seat Adjustment Service Scenario

A fourth scenario S114 is a seat adjustment service scenario. The seat system 360 may adjust at least one element of the seat that matches the user based on the acquired physical information.

5) Personal Content Provision Scenario

A fifth scenario S115 is a personal content provision scenario. A display system 350 can receive personal data of the user via an input device 310 or a communication device 330. The display system 350 can provide a content corresponding to the personal data of the user.

6) Product Provision Scenario

A sixth scenario S116 is a product provision scenario. A cargo system 355 can receive user data through the input device 310 or the communication device 330. The user data may include preference data of the user and destination data of the user. The cargo system 355 may provide a product based on the user data.

7) Payment Scenario

A seventh scenario S117 is a payment scenario. A payment system 365 can receive data for price calculation from at least one of the input device 310, the communication device 330 and the cargo system 355. The payment system 365 can calculate a vehicle usage price of the user based on the received data. The payment system 365 can require the user (that is, mobile terminal of user) to pay a fee at the calculated price.

8) User Display System Control Scenario

An eighth scenario S118 is a user display system control scenario. The input device 310 may receive a user input configured in at least one form and may convert the user input into an electrical signal. The display system 350 can control a content displayed based on the electrical signal.

9) AI Agent Scenario

A ninth scenario S119 is a multi-channel artificial intelligence (AI) agent scenario for multiple users. An AI agent 372 can distinguish the user input of each of multiple users. The AI agent 372 can control at least one of the display system 350, the cargo system 355, the seat system 360, and the payment system 365 based on the electric signal converted from the user input of each of the multiple users.

10) Multimedia Content Provision Scenario for Multiple Users

A tenth scenario S120 is a multimedia content provision scenario for multiple users. The display system 350 can provide a content that all users can view together. In this case, the display system 350 can individually provide the same sound to multiple users through a speaker provided in each sheet. The display system 350 can provide a content that the multiple users individually can view. In this case, the display system 350 can provide an individual sound through the speaker provided in each sheet.

11) User Safety Securing Scenario

An eleventh scenario S121 is a user safety securing scenario. When vehicle peripheral object information that poses a threat to the user is acquired, the main controller 370 can control to output an alarm of the vehicle peripheral object via the display system 350.

12) Belongings Loss Prevention Scenario

A twelfth scenario S122 is a scenario for preventing loss of belongings of the user. The main controller 370 can obtain data on the belongings of the user via the input device 310. The main controller 370 can obtain user motion data through the input device 310. The main controller 370 can determine whether the user places the belongings and gets off based on the data of the belongings and the motion data. The main controller 370 can control to output an alarm of the belongings through the display system 350.

13) Get Off Report Scenario

A thirteenth scenario S123 is a get off report scenario. The main controller 370 can receive get off data of the user through the input device 310. After the user gets off, the main controller 370 can provide report data for the get off to the mobile terminal of the user through the communication device 330. The report data may include the entire usage fee data of the vehicle 10.

Vehicle-to-Everything (V2X)

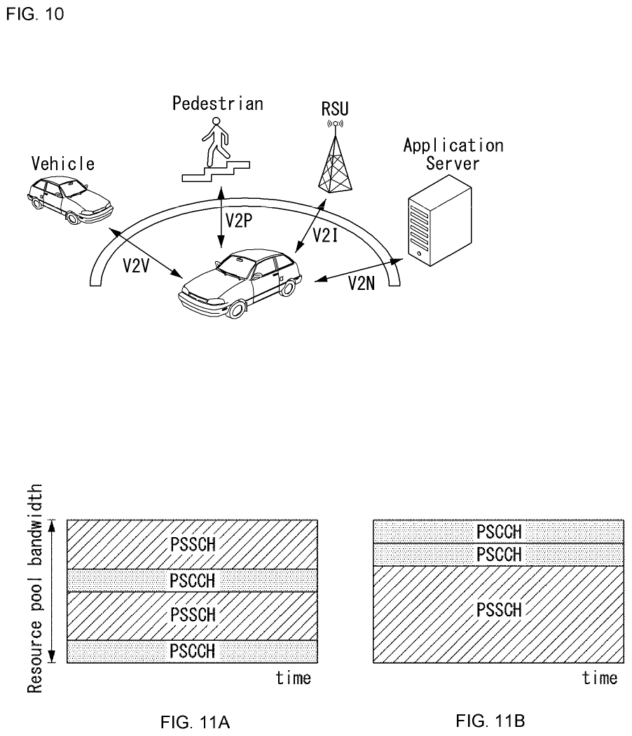

FIG. 10 is an example of V2X communication to which the present disclosure is applicable.

The V2X communication includes communication between a vehicle and all objects such as Vehicle-to-Vehicle (V2V) referring to communication between vehicles, Vehicle-to-Infrastructure (V2I) referring to communication between a vehicle and an eNB or a Road Side Unit (RSU), and Vehicle-to-Pedestrian (V2P) or a Vehicle-to-Network (V2N) referring to communication between a vehicle and a UE with an individual (pedestrian, bicycler, vehicle driver, or passenger).

The V2X communication may indicate the same meaning as V2X side-link or NR V2X, or may include a broader meaning including the V2X side-link or NR V2X.

For example, the V2X communication can be applied to various services such as forward collision warning, an automatic parking system, a cooperative adaptive cruise control (CACC), control loss warning, traffic matrix warning, traffic vulnerable safety warning, emergency vehicle warning, speed warning on a curved road, or a traffic flow control.

The V2X communication can be provided via a PC5 interface and/or a Uu interface. In this case, in a wireless communication system that supports the V2X communication, there may exist a specific network entity for supporting the communication between the vehicle and all the objects. For example, the network object may be a BS (eNB), the road side unit (RSU), a UE, an application server (for example, a traffic safety server), or the like.

In addition, the UE executing V2X communication includes not only a general handheld UE but also a vehicle UE (V-UE), a pedestrian UE, a BS type (eNB type) RSU, a UE type RSU, a robot having a communication module, or the like.

The V2X communication may be executed directly between UEs or may be executed through the network object(s). V2X operation modes can be divided according to a method of executing the V2X communication.

The V2X communication requires a support for UE pseudonymity and privacy when a V2X application is used so that an operator or a third party cannot track a UE identifier within a V2X support area.

Terms frequently used in the V2X communication are defined as follows.
Road Side Unit (RSU): The RSU is a V2X serviceable device that can perform transmission/reception with a moving vehicle using a V2I service. Furthermore, the RSU can exchange messages with other entities supporting the V2X application as a fixed infrastructure entity supporting the V2X application. The RSU is a term often used in the existing ITS specifications, and a reason for introducing this term in 3GPP specifications is to make it easy to read a document in an ITS industry. The RSU is a logical entity that combines a V2X application logic with functions of a BS (referred to as BS-type RSU) or a UE (referred to as UE-type RSU).
V2I service: A type of V2X service in which one is a vehicle and the other is an entity belongs to an infrastructure.
V2P service: A type of the V2X service in which one is a vehicle and the other is a device (for example, handheld UE carried by pedestrian, bicycler, driver, or passenger) carried by an individual.
V2X service: A 3GPP communication service type in which a transmitting or receiving device is related to a vehicle.
V2X enabled UE: A UE supporting the V2X service.
V2V service: A type of the V2X service in which both in the communication are vehicles.
V2V communication range: A range of direct communication between two vehicles participating in the V2V service.

As described above, the V2X application referred to as the V2X (Vehicle-to-Everything) includes four types such as (1) Vehicle-to-Vehicle (V2V), (2) Vehicle-to-infrastructure (V2I), (3) Vehicle-to-Network (V2N), and (4) Vehicle-to-Pedestrian (V2P).

FIGS. 11A and 11B show a resource allocation method in a side-link where the V2X is used.

In the side-link, different physical side-link control channels (PSCCHs) may be separately allocated in a frequency domain, and different physical side-link shared channels (PSSCHs) may be separately allocated. Alternatively, different PSCCHs may be allocated consecutively in the frequency domain, and PSSCHs may also be allocated consecutively in the frequency domain.

NR V2X

In order to extend a 3GPP platform to a vehicle industry during 3GPP release 14 and 15, supports for the V2V and V2X services are introduced in LTE.

Requirement for supports with respect to an enhanced V2X use case are broadly divided into four use case groups.

(1) A Vehicle Platooning can dynamically form a platoon in which vehicles move together. All vehicles in the platoon get information from the top vehicle to manage this platoon. These pieces of information allow the vehicles to be operated in harmony in the normal direction and to travel together in the same direction.

(2) Extended sensors can exchange raw data or processed data collected by a local sensor or a live video image in a vehicle, a road site unit, a pedestrian device, and a V2X application server. In the vehicle, it is possible to raise environmental awareness beyond what a sensor in the vehicle can sense, and to ascertain broadly and collectively a local situation. A high data transmission rate is one of main features.

(3) Advanced driving allows semi-automatic or full-automatic driving. Each vehicle and/or the RSU shares own recognition data obtained from the local sensor with a proximity vehicle and allows the vehicle to synchronize and coordinate a trajectory or maneuver. Each vehicle shares a driving intention with the proximity vehicle.

(4) Remote driving allows a remote driver or the V2X application to drive the remote vehicle for a passenger who cannot drive the remote vehicle in his own or in a dangerous environment. If variability is restrictive and a path can be forecasted as public transportation, it is possible to use Cloud computing based driving. High reliability and a short waiting time are important requirements.

The above-described 5G communication technology can be applied in combination with methods proposed in the present disclosure described later or can be supplemented to embody or clarify technical features of methods proposed in the present disclosure.

Hereinafter, various embodiments of the present disclosure will be described in detail with reference to the accompanying drawings.

MEC Server

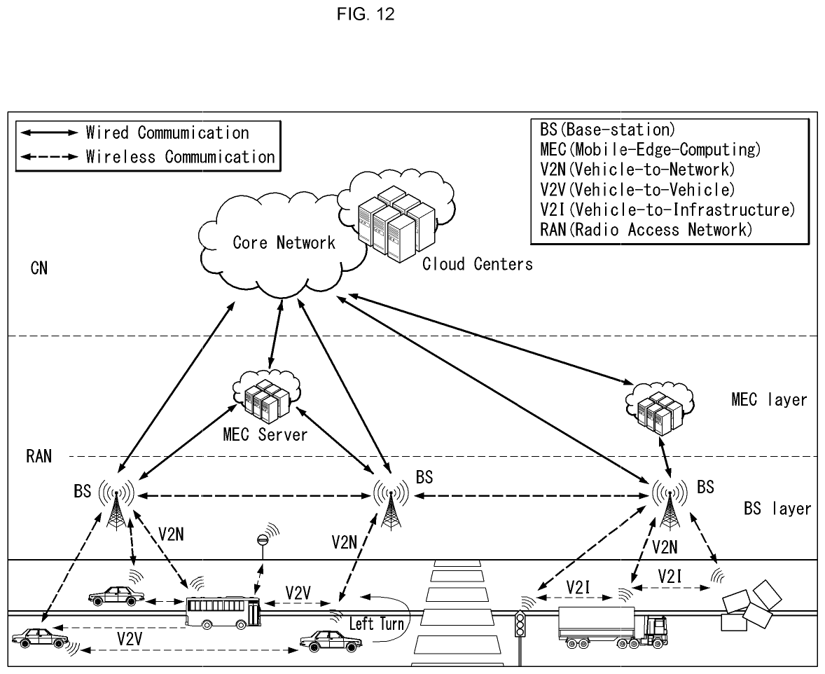

FIG. 12 shows an architecture of a mobile edge computing (MEC) server applicable to the present disclosure.

The MEC server not only can perform a role of a normal server but also can provide flexible vehicle related services and allow efficient network operation by being connected to a base station (BS) near a road in a radio access network (RAN). Particularly, a network-slicing and traffic scheduling policy supported by the MEC server can aid in network optimization.

In the architecture, MEC servers may be integrated in the RAN and located at an SI-user plane interface (for example, between a core network and a BS) in a 3GPP system. Each MEC server can be regarded as an independent network element and does not affect connection of existing wireless networks. An independent MEC server is connected to a BS through a dedicated communication network and can provide specific services to various end-users located in the corresponding cell. Such an MEC server and a cloud server are connected through Internet-backbone and can share information. Although the Internet-backbone is connected in a wired manner in the architecture, the Internet-backbone may be connected in a wireless manner according to a configuration method.

The MEC server is independently operated and can control a plurality of BSs. Particularly, the MEC server performs services for autonomous vehicles, an application operation such as a virtual machine (VM), and an operation at a mobile network edge based on a virtualization platform.

A base station (BS) is connected to MEC servers and a core network to facilitate flexible user traffic scheduling required to execute provided services.

The MEC server and a 3G radio network controller (RNC) are located at similar network levels but the following differences are present therebetween.
Dozens, hundreds or more of BSs can be controlled by the RNC, and transmission delay occurrence increases as the number of configured BSs increases. However, the MEC server directly interacts with less than 10 BSs in general and thus can prevent excessive transmission delay.
In addition, since the MEC server in the architecture provides efficient communication between a BS and the core network and also permits previous communication between BSs and between a BS and the core network, the MEC server can be used in the corresponding network.
When large-capacity user traffic is generated in a specific cell, the MEC server can perform task offloading and cooperation processing on the basis of an interface between neighboring BSs.
The RNC provides only a fixed function for wireless network control, whereas the MEC server has an open operation environment based on software and thus new services of application providers can be easily provided.

The architecture including the MEC server can provide the following advantages.

Service waiting time reduction: A data reciprocating time is reduced and a service provision speed is high because services are performed near end-users.
Flexible service provision: MEC applications and virtual network functions (VNF) provide flexibility and geographical distribution in service environments. Various applications and network functions can be programmed and only a specific user group can be selected or compiling only for the specific user group can be performed using such a virtualization technique. Accordingly, provided services can be applied more closely to user requirements.
Cooperation between BSs: The MEC server has central control capability and can minimize interaction between BSs. This can simplify a process for executing basic functions of a network such as handover between cells. Such a function can be useful in automated vehicle & highway systems having many users.
Minimization of congestion: Terminals on roads periodically generate a large amount of small packets in automated vehicle & highway systems. The MEC server in RNC can reduce the amount of traffic that needs to be transmitted to a core network by performing a specific service and thus decrease processing loads of a cloud in a centralized cloud system and minimize network congestion.
Reduction of operation expenses: The MEC server integrates a network control function and individual services and thus can increase profitability of mobile network operators (MNOs) and facilitates rapid and efficient maintenance and upgrade through installation density adjustment.

In the present disclosure, when an autonomous traveling service is universalized, data processing using the MEC server inevitably increases. However, high purchasing/maintenance costs may occur if a MEC server with high specifications is purchased for high speed data processing. In addition, in an area (for example, an area with low traffic) where server utilization is low, the server with high specifications may be left idle, which causes wasted costs. Then, if many vehicles are simultaneously connected to an area-based MEC server (for example, when a traffic volume increases), data processing delay/loss occurs, which may affect safety of the autonomous vehicle. Therefore, the present disclosure provides a technology for the vehicle to perform distributed transmission/processing of data to a plurality of servers according to a function by searching the MEC server having optimum performance according to a function to be processed.

Therefore, in the present disclosure, each MEC server sets a main processing function according to performance (HW/SW) of the server, and the vehicle monitors the MEC server with surrounding base stations while traveling. The vehicle selects a data processing server based on the main processing function of each MEC server and the traffic information. In the data processing server, a plurality of data processing servers can correspond to a vehicle.

When a connection loss occurs during data transmission/reception, a loss countermeasure server is searched to process data, and the loss countermeasure server researches and selects an alternate server through a Cloud. If the alternate server search fails, the data can be processed by the Cloud.

As a result, in the present disclosure, a processing speed above a certain level can be guaranteed by selecting the MEC server that high efficiency can be expected according to the data processing function. In addition, it is possible to prevent waste of a MEC resource by setting the performance of the MEC server as needed according to the data processing function. Since data is transmitted to be distributed to a plurality of MEC servers simultaneously, even when disconnected to a specific MEC, data processing persistence can be secured through other MEC servers. In addition, it is possible to secure a stable processing speed due to the traffic distribution of the MEC servers.

Setting of Main Processing Function of Server

The main processing function can be set according to hardware performance of the server and the application executed on the server. Depending on the set main processing function, a type of data transmitted from the vehicle may differ.

(1) For example, the type of the main processing function may be a media data processing function, a single data processing function, and a data combination function, and embodiments are as follows.
Media data processing function: Object detection function, media streaming
Single data processing function: Specific object detection function
Data combination function: High precision map information generation, traveling route search function based on traffic information

(2) Server characteristics required for each main processing function can be divided into hardware (for example, Graphics Processing Unit (GPU)/memory/CPU/HDD) and an application (for example, distributed processing SW), and embodiments are as follows.
Media data processing function: GPU or distributed processing SW with high specifications is required for very complex arithmetic processing (for example, 1080 GTX ti (GPU)/Hadoop or CUDA (SW))
Single data processing function: General performance (for example, memory 4G/SSD 256/intel core i3/specific application is not required)
Data combination function: High specification performance is required as it has to be combined with data transmitted through other networks (for example, memory 8G/SSD 1T/intel core i5/specific application is not required)

Server Determination Method

A large number of base stations and servers may be located on the traveling route of the vehicle. The vehicle monitors surrounding connectable base stations while traveling, and receives information on a server that can be connect to each base station.

For example, the information of these servers may include the following information.
Server IP address/server base station information/server current occupancy traffic/main processing function information

The vehicle searches and determines a suitable server for each processing function requested by the vehicle based on the received server information. Embodiments are as follows.
Main processing function suitability check: Check a server in which the processing function required by the vehicle and the main processing function match with each other.
Occupancy traffic check: Select a server having the lowest occupancy traffic among the servers checked to be suitable to the main processing function.

At this time, the vehicle can process data using own application resource without using the server when there is no server having the suitable main processing function and all occupancy traffics are the maximum value.

The vehicle transmits suitable data to the selected server and receives processing results. Embodiments are as follows.
Media data processing function: Video streaming data transmission
Single data processing function (for example, object detection): Sensor data transmission
Data combination function (for example, high precision map information generation): Vehicle position information, sensor data transmission

When Disconnected to Server

The vehicle monitors a communication status with the server continuously while transmitting and receiving data. When a connection to a specific server during the data transmission is lost, the loss countermeasure server is searched based on loss countermeasure server search information in the already connected server, and the data is transmitted to the set loss countermeasure server based on a loss countermeasure server setting criteria. In order to connect to the loss countermeasure server, the loss countermeasure server search information may include the information of the above-described server, and embodiments are as follows.
Loss countermeasure server search information: Traffic state information of server, communication status information with vehicle
Loss countermeasure server setting criteria: Low traffic state information of server, communication status connectable to vehicle

The vehicle can temporarily process the data through the loss countermeasure server determined in this way. However, since the loss countermeasure server is not the server having the suitable main processing function, much time may be consumed for the data processing. Therefore, while the loss countermeasure server processes data, an alternate server search is requested to the Cloud. Embodiments are as follows.
Search condition: Whether the server matches with the main processing function, whether the current traffic state of the server is sufficient to process the data, whether the server can be used on the traveling route based on the position information of the server

Alternative Server: Server Matching the Search Condition

When the search and determination of the alternate server is completed, information of the alternate server is transmitted to the vehicle, and the data processed by the loss countermeasure server and processing results are also transmitted to the alternate server. The alternate server processes the data.

If the search for the alternate server fails, information of the Cloud server is transmitted to the vehicle. Accordingly, the vehicle can be connected to the Cloud server to transmit and receive data and can receive processing results.

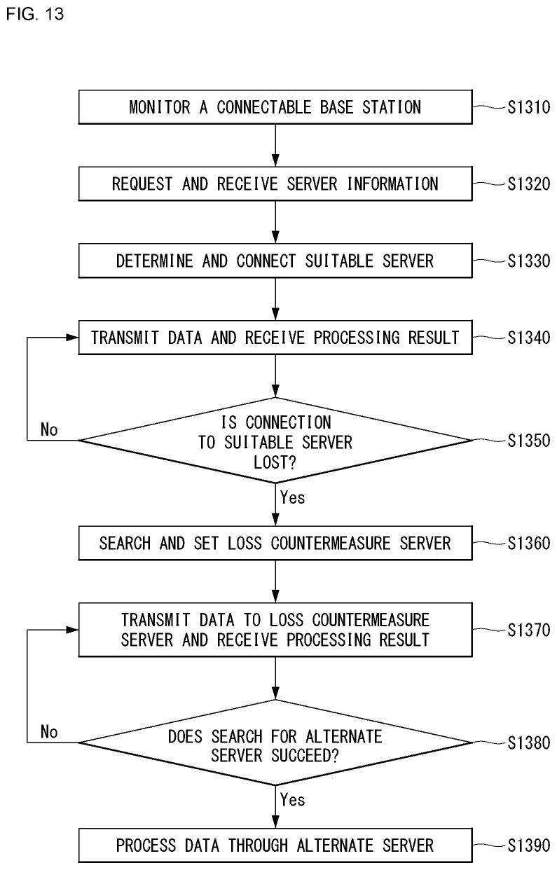

FIG. 13 is an embodiment of a vehicle to which the present disclosure is applicable.

The vehicle monitors a connectable base station while traveling (S1310).

The vehicle requests server information through the connectable base station to the server connected to the base station and receives the server information (S1320).

The vehicle determines the suitable server based on the received server information, and connects communication (S1330). For this, the vehicle uses information on the required processing function to check whether the main processing function is suitable, and is connected to the server having the lowest occupancy traffic among servers in which suitability of the main processing function is checked.

The vehicle transmits data to the connected suitable server and receives processing results (S1340).

The vehicle may monitor whether the connection to the suitable server is lost while traveling (S1350).

When the connection to the suitable server is lost and data transmission is not possible, the vehicle searches and determines the loss countermeasure server (S1360). The loss countermeasure server may be a server that satisfies the loss countermeasure server setting criteria selected among candidate servers connectable to the vehicle, using the above-described loss countermeasure server search information.

The vehicle transmits data to the set loss countermeasure server and receives processing results associated with this (S1370).

While the vehicle processes data through the loss countermeasure server, the loss countermeasure server request an alternate server search to the Cloud. When the server search matching the search condition succeeds by the Cloud, the Cloud transmits information of the alternate server to the vehicle (S1380).

The vehicle can be connected to the alternate server using the received information on the alternate server, and can execute data processing through the alternate server (S1390).

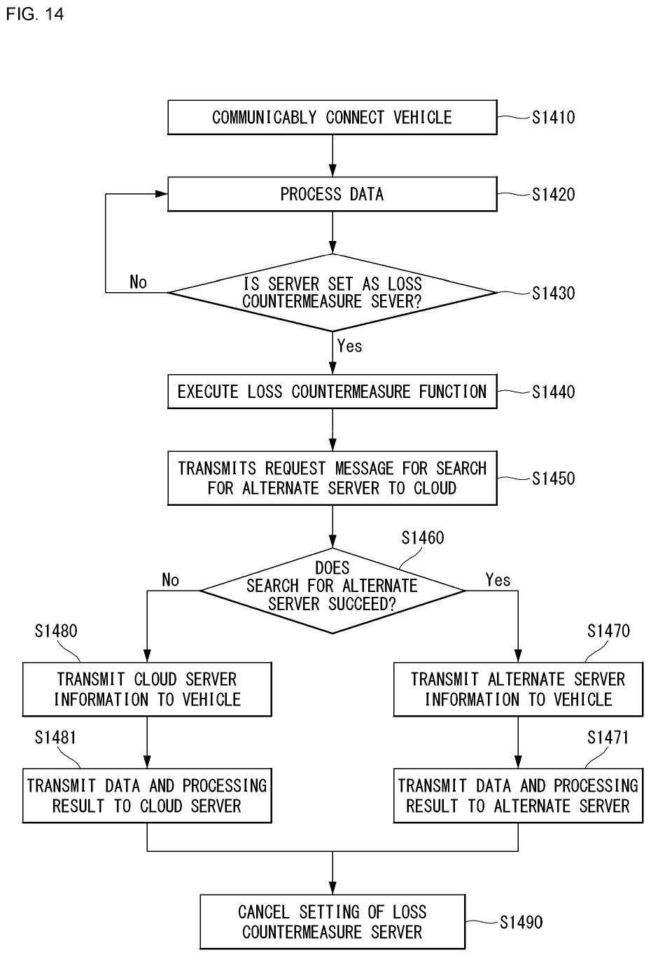

FIG. 14 is an embodiment of a server to which the present disclosure is applicable.

Accordingly to the request of the vehicle, the server is communicably connected to the vehicle (S1410).

The server receives the data transmitted from the vehicle according to the main processing function information set in the server and processes the data (S1420).

The server determines from the vehicle whether the server is set as the loss countermeasure server (S1430).

If it is determined that the server is not connected to the vehicle as the suitable server and is connected to a vehicle as a loss countermeasure server, the server processes the data received from the vehicle and starts a loss countermeasure function for the alternate server search (S1440).

The server transmits a request message for search for the alternate server to the connected Cloud (S1450).

The server can receive a search success message of the alternate server from the Cloud (S1460). The success messages may include information of alternate server.

When the success message is received, the server transmits the information of the alternate server to the vehicle so that the vehicle can be connected to the alternate server (S1470).

In addition, the server transmits data being processed and processing results to the alternate server for continuity of data processing (S1471).

When the success message is not received, the server transmits information of the Cloud server to the vehicle so that the vehicle can process the data through the Cloud (S1480). For this, the Cloud may transmit information of the Cloud server to the server instead of the success message.

In addition, the server transmits the data being processed and the processing result to the Cloud for the consecutively of data processing (S1481).

The server can cancel the setting to the loss countermeasure server and can operate as a general server (S1490).

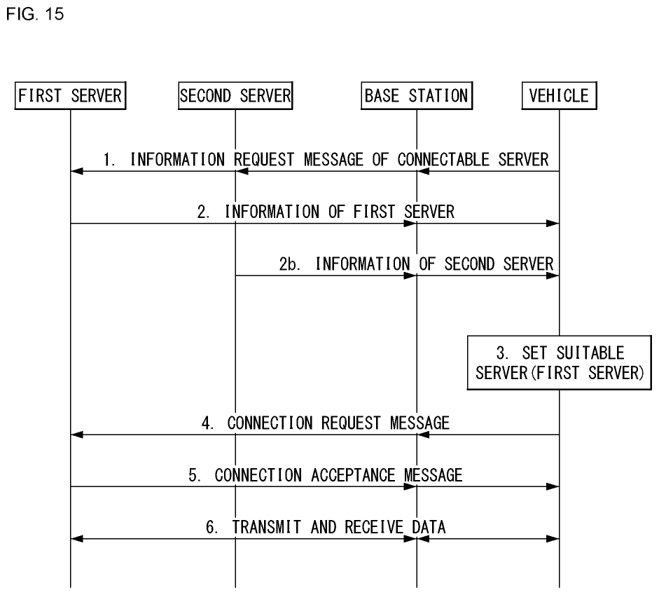

FIG. 15 is an example of setting of the suitable server to which the present disclosure is applied.

1. The vehicle transmits a request message through the connected base station to request information of the connectable servers. The base station that receives the request message from the vehicle can transmit the request message to the connected first server and second server.

2. The first server and the second server that receive the request message transmit the information of the above-described server to the vehicle.

3. The vehicle sets the suitable server based on the received information of the server. For example, when the main processing function of the first server matches with the processing function requested by the vehicle, and a current occupancy traffic of the first server is lower than that of the second server, the first server may be set as a suitable server.

4. The vehicle transmits a connection request message to the first server set as a suitable server.

5. The first server that receives the connection request message transmits a connection acceptance message to the vehicle as a response to this connection.

6. A data route is established between the first server and the vehicle through steps 4 and 5, which allows the vehicle to transmit and receive the data to and from the first server.

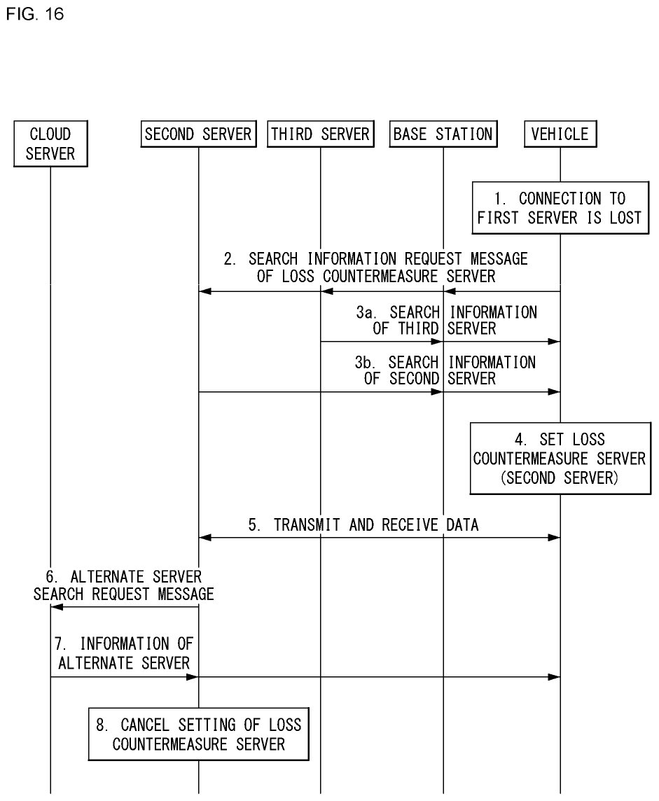

FIG. 16 shows an example in which the connection to the server applied to the present disclosure is lost.

1. A vehicle connected to the first server may be out of a coverage of the previously connected base station during traveling and loss of connection with the first server due to deterioration of the communication environment or the like may occur.

2. The vehicle transmits a request message requesting search information of the loss countermeasure server through the connectable base station at a current position, and the base station transmits the request message to the connected server.

3. The server that receives the request message transmits the search information of the server to the vehicle.

4. Based on the loss countermeasure server search information received, the vehicle can set the loss countermeasure server according to the loss countermeasure server setting criteria. For example, based on the traffic state information and communication status information suggested by the search information of the second server, when the second server has the traffic state information lower than that of the third server and has a communication status connectable to the vehicle, the second server can be set as the loss countermeasure server.

5. The vehicle establishes the second server set to the loss countermeasure server and a data route, and thus, can transmits and receives the data to and from the second server through this establishment.

6. The second server set as the loss countermeasure server transmits an alternate server search request message to the Cloud server.

7. The Cloud server that receives the alternate server search request message can transmit the information of the alternate server to the vehicle through the second server as a response to this message.

8. The second server that receives the information of the alternate server can cancel the setting as the loss countermeasure server.

Device to which Present Disclosure is Applicable

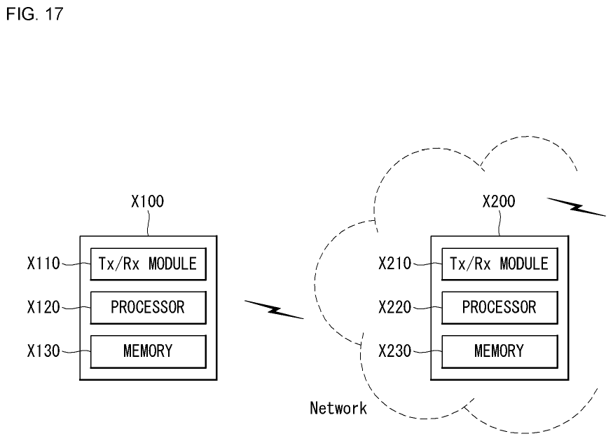

Referring to FIG. 17, a server X200 according to a proposed embodiment may be the MEC server or the Cloud server, and may include a communication module X210, a processor X220 and a memory X230. The communication module X210 is also referred to as a radio frequency (RF) unit. The communication module X210 can be configured to transmit various signals, data, and information to an external device, and to receive various signals, data, and information from the external device. The server X200 can be connected to the external device in wired and/or wireless manner. The communication module X210 can be implemented to be divided into a transmission unit and a receiving unit. The processor X220 can control all operations of the server X200, and the server X200 can be configured to execute a function of computing information or the like to be transmitted and received to and from the external device. In addition, the processor X220 can be configured to execute a server operation provided by the present disclosure. The processor X220 can control the communication module X210 to transmit data or a messages to the UE, other vehicles, or other servers based on a proposal of the present disclosure. The memory X230 can save arithmetically processed information or the like during a specified period of time, and can be replaced with a component such as a buffer.

Moreover, the specific configurations of the terminal device X100 and the server X200 as described above can be implemented such that contents described in various embodiments of the above-described present disclosure are independently applied or two or more embodiments are applied at the same time, and the overlapping contents are omitted for clarity.

Embodiments to which the present disclosure is applicable

### Embodiment 1

A method for setting a connection between a vehicle and a server in automated vehicle & highway systems, the method including: requesting server information to a base station to establish a communication connection to the server and receiving the server information related to one or more servers connected to the base station; determining a first server to execute a function required by an application of the vehicle, based on the server information; and establishing the communication connection to the first server, in which the server information includes function information executable based on an Internet Protocol (IP) address of the server and specifications of the server, and the function information includes a priority value.

### Embodiment 2

In Embodiment 1, when the communication connection to the first server is lost, the method further includes transmitting a search information request message for searching a loss countermeasure server that is an alternate server of the first server; setting the loss countermeasure server based on the search information; and establishing a communication connection to the loss countermeasure server, in which the search information includes traffic status information of the server and communication status information that indicates whether a communication connection to the vehicle is possible.

### Embodiment 3

In Embodiment 1, the function information includes a single data processing function for processing a single data type, a media data processing function for processing a media data type, and a data combination function for combining and processing different data types.

### Embodiment 4

In Embodiment 3, the server information further includes traffic information of the server, and the determining the first server includes determining, based on the function information and the traffic information, a server that is mapped to a function required by the application and has a lowest current traffic, as the first server.

### Embodiment 5

In Embodiment 4, when the function required by the application includes an object detection function or a media streaming function, the function required by the application is mapped to the media data processing function.

### Embodiment 6

In Embodiment 4, when the function required by the application includes a map information generation function or a traveling route search function based on traffic information, the function required by the application is mapped to the data combination function.

### Embodiment 7

In Embodiment 2, the setting the loss countermeasure server includes setting a server, which has a communication status connectable to the vehicle and has a lowest current traffic, as the loss countermeasure server.

### Embodiment 8

In Embodiment 2, the method further includes receiving server information of a second server that is an alternate server of the loss countermeasure server, and the second server executes a function mapped to the function required by the application based on the server information of the second server and has a traffic status that executes the function.

### Embodiment 9

A method for setting a connection between a server and a vehicle in automated vehicle & highway systems, including: establishing a communication connection to the vehicle; and requesting a search for an alternate server playing a role of the server to a Cloud server when the server is set to the loss countermeasure server, in which the loss countermeasure server is a server that is temporarily connected to the vehicle to prevent loss of data related to an operation executed by the application caused by a communication disconnection to the server connected to the application of the vehicle.

### Embodiment 10

In Embodiment 9, the method further includes transmitting server information of the alternate server to the vehicle when a success message indicating that the search for the alternate server succeeds is received; and canceling the setting of the loss countermeasure server, and the server information of the alternate server includes information for establishing a communication connection between the vehicle and the alternate server.

### Embodiment 11

In Embodiment 10, the method further includes transmitting server information of the Cloud server to the vehicle when the success message is not received, and the server information of the Cloud server includes information for establishing a communication connection between the vehicle and the Cloud server.

### Embodiment 12

In Embodiment 9, the method further includes transmitting search information allowing the vehicle to set the loss countermeasure server, and the search information includes traffic status information of the server and communication status information that indicates whether a communication connection to the vehicle is possible.

### Embodiment 13

In Embodiment 12, the loss countermeasure server has a communication status connectable to the vehicle and is set as a server having a lowest current traffic.

### Embodiment 14

In Embodiment 9, the alternate server has a traffic status in which a function executable by the alternate server is mapped to a function required by the application and which has a traffic status executing the function and is connectable to the vehicle.

### Embodiment 15

In Embodiment 9, the server is a mobile edge computing (MEC) server.

### Embodiment 16

A vehicle executing a method for setting a connection between a vehicle and a server in automated vehicle & highway systems, the vehicle including: a communication module; a memory; and a processor, in which the processor request server information for establishing a communication connection to the server to a base station through the communication module, receives the server information related to one or more servers connected to the base station, determines a first server to execute a function required by an application of the vehicle based on the server information, and establishes the communication connection to the first server, and the server information includes function information executable based on an Internet Protocol (IP) address of the server and specifications of the server, and the function information includes a priority value.

### Embodiment 17

In Embodiment 16, when the communication connection to the first server is lost, the processor transmits a search information request message for searching a loss countermeasure server which is an alternate server of the first server through the communication module, sets the loss countermeasure server based on the search information, and establishes a communication connection to the loss countermeasure server, and the search information includes traffic status information of the server and communication status information that indicates whether a communication connection to the vehicle is possible.

### Embodiment 18

In Embodiment 16, the function information includes a single data processing function for processing a single data type, a media data processing function for processing a media data type, and a data combination function for combining and processing different data types.

### Embodiment 19

In Embodiment 17, the server information further includes traffic information of the server, and the processor determines, based on the function information and the traffic information, a server that is mapped to a function required by the application and has a lowest current traffic, as the first server.

### Embodiment 20

In Embodiment 19, when the function required by the application includes an object detection function or a media streaming function, the function required by the application is mapped to the media data processing function.

### Embodiment 21

In Embodiment 19, when the function required by the application includes map information generation function or a traveling route search function based on traffic information, the function required by the application is mapped to the data combination function.

### Embodiment 22

In Embodiment 17, the processor has a communication status connectable to the vehicle and sets a server having a lowest current traffic as the loss countermeasure server.

### Embodiment 23

In Embodiment 17, the processor receives server information of a second server that is an alternate server of the loss countermeasure server, through the communication module, and the second server executes a function mapped to the function required by the application based on the server information of the second server and has a traffic status that executes the function.

The above-described present disclosure can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

Furthermore, although the invention has been described with reference to the exemplary embodiments, those skilled in the art will appreciate that various modifications and variations can be made in the present disclosure without departing from the spirit or scope of the invention described in the appended claims. For example, each component described in detail in embodiments can be modified. In addition, differences related to such modifications and applications should be interpreted as being included in the scope of the present disclosure defined by the appended claims.

The present disclosure is described with reference to the example applied to the automated vehicle & highway systems based on the 5G (5 generation) system. However, the present disclosure can be applied to various wireless communication systems and autonomous devices.

According to an embodiment, it is possible to connect the suitable server capable of executing the function required by the application of the vehicle in an automatic vehicle & highway systems.

According to an embodiment, it is possible to temporarily connect the loss countermeasure server when a connection to the server is lost.

According to an embodiment, it is possible to search and connect a suitable server capable of substituting for the loss countermeasure server. Effects obtained in the present disclosure are not limited to the effects mentioned above, and other effects not mentioned can be clearly understood by a person skilled in the art from the above descriptions.

What is claimed is:

1. A method for setting a connection between a vehicle and a server in automated vehicle & highway systems, the method comprising:
requesting server information to a base station to establish a communication connection to the server and receiving the server information related to one or more servers connected to the base station;
determining a first server to execute a function required by an application of the vehicle, based on the server information; and
establishing the communication connection to the first server,
wherein the server information includes function information executable based on an Internet Protocol (IP) address of the server and specifications of the server, and the function information includes a priority value.

2. The method of claim 1, further comprising:
if the communication connection to the first server is lost,
transmitting a search information request message for searching a loss countermeasure server that is an alternate server of the first server;
setting the loss countermeasure server based on the search information; and
establishing a communication connection to the loss countermeasure server,
wherein the search information includes traffic status information of the server and communication status information that indicates whether a communication connection to the vehicle is possible.

3. The method of claim 1, wherein the function information includes a single data processing function for processing a single data type, a media data processing function for processing a media data type, and a data combination function for combining and processing different data types.

4. The method of claim 3, wherein the server information further includes traffic information of the server, and the determining the first server includes determining, based on the function information and the traffic information, a server that is mapped to a function required by the application and has a lowest current traffic, as the first server.

5. The method of claim 4, wherein if the function required by the application includes an object detection function or a media streaming function, the function required by the application is mapped to the media data processing function.

6. The method of claim 4, wherein if the function required by the application includes a map information generation function or a traveling route search function based on traffic information, the function required by the application is mapped to the data combination function.

7. The method of claim 2, wherein the setting the loss countermeasure server includes setting a server, which has a communication status connectable to the vehicle and has a lowest current traffic, as the loss countermeasure server.

8. The method of claim 2, further comprising:
receiving server information of a second server that is an alternate server of the loss countermeasure server,
wherein the second server executes a function mapped to the function required by the application based on the server information of the second server and has a traffic status that executes the function.

9. A method for setting a connection between a server and a vehicle in automated vehicle & highway systems, the method comprising:
establishing a communication connection to the vehicle; and
requesting a search for an alternate server playing a role of the server to a Cloud server if the server is set to the loss countermeasure server,
wherein the loss countermeasure server is a server that is temporarily connected to the vehicle to prevent loss of data related to an operation executed by the application caused by a communication disconnection to the server connected to the application of the vehicle.

10. The method of claim 9, further comprising:
transmitting server information of the alternate server to the vehicle if a success message indicating that the search for the alternate server succeeds is received; and
canceling the setting of the loss countermeasure server,
wherein the server information of the alternate server includes information for establishing a communication connection between the vehicle and the alternate server.

11. The method of claim 10, further comprising:
transmitting server information of the Cloud server to the vehicle if the success message is not received,
wherein the server information of the Cloud server includes information for establishing a communication connection between the vehicle and the Cloud server.

12. The method of claim 9, further comprising:
transmitting search information allowing the vehicle to set the loss countermeasure server,
wherein the search information includes traffic status information of the server and communication status information that indicates whether a communication connection to the vehicle is possible.

13. The method of claim 12, wherein the loss countermeasure server has a communication status connectable to the vehicle and is set as a server having a lowest current traffic.

14. The method of claim 9, wherein the alternate server has a traffic status in which a function executable by the alternate server is mapped to a function required by the application and which has a traffic status executing the function and is connectable to the vehicle.

15. The method of claim 9, wherein the server is a mobile edge computing (MEC) server.

16. A vehicle executing a method for setting a connection between a vehicle and a server in automated vehicle & highway systems, the vehicle comprising:
a transceiver;
a memory; and
a processor,
wherein the processor requests server information for establishing a communication connection to the server to a base station through the transceiver, receives the server information related to one or more servers connected to the base station, determines a first server to execute a function required by an application of the vehicle based on the server information, and establishes the communication connection to the first server, and
the server information includes function information executable based on an Internet Protocol (IP) address of the server and specifications of the server, and the function information includes a priority value.

17. The vehicle of claim 16, wherein if the communication connection to the first server is lost, the processor transmits a search information request message for searching a loss countermeasure server which is an alternate server of the first server through the transceiver, sets the loss countermeasure server based on the search information, and establishes a communication connection to the loss countermeasure server, and
the search information includes traffic status information of the server and communication status information that indicates whether a communication connection to the vehicle is possible.

18. The vehicle of claim 16, wherein the function information includes a single data processing function for processing a single data type, a media data processing function for processing a media data type, and a data combination function for combining and processing different data types.

19. The vehicle of claim 18, wherein the server information further includes traffic information of the server, and
the processor determines, based on the function information and the traffic information, a server that is mapped to a function required by the application and has a lowest current traffic, as the first server.

20. The vehicle of claim 17, wherein the processor receives server information of a second server that is an alternate server of the loss countermeasure server, through the transceiver, and
the second server executes a function mapped to the function required by the application based on the server information of the second server and has a traffic status that executes the function.
